(19) United States
(12) Patent Application Publication
(10) Pub. No.: US 2019/0210417 A1
(43) Pub. Date: Jul. 11, 2019

(54) Universal Threaded Novelty Mount and Method of Use

(71) Applicant: Mark Thomas, Fernley, NV (US)

(72) Inventor: Mark Thomas, Fernley, NV (US)

(21) Appl. No.: 16/238,532

(22) Filed: Jan. 3, 2019

Related U.S. Application Data
(60) Provisional application No. 62/614,526, filed on Jan. 8, 2018.

(51) Int. Cl. B60C 29/06; F16K 27/08

(52) U.S. Cl. CPC B60C 29/066; F16K 27/08

(57) ABSTRACT

A universal threaded novelty mount is used to mount a threaded novelty item such as a threaded wheel light, threaded valve cap, and/or threaded figurine designed to thread onto a common American, and/or French mouth tire (tyre) valve stem.

### LIST OF REFERENCE NUMERALS

8 Threaded shaft, and/or mast coupling structure.
9 Silicone, and/or elastic strap coupling structure.
20 Velcro coupling structure.
22 Suction cup coupling structure.
23 Adhesive coupling structure.
24 Threaded bolt, and/or through hole coupling structure.
25 Aperture, coupling structure.
26 Spring coupling structure.
27 Crimp, and/or glue rope, cable coupling structure.
28 Magnetic coupling structure.
29 Clamp coupling structure.
30 Velcro.
31 Bolt head.
32 Suction.
33 Adhesive.
34 Through hole.
35 Aperture.
36 Spring.
37 Crimp, glue.
38 Magnetic.
39 clamp.
40 Form fit coupling structure.
41 Form fit, adhesive coupling structure.
42 Form fit, magnetic coupling structure.
43 Form fit Velcro coupling structure.
100 Mast
101 Pencil
110 Threaded novelty item
113 Wheelchair
114 ATV (all terrain vehicle)
115 Golf cart
116 Boat
117 Car
120 Rope, and/or cable
210 Bolt, and/or bolt head
211 Nut

### FIELD OF THE INVENTION

The present invention relates generally to threaded novelty items and more particularly to a threaded coupling mount used to attach a threaded novelty item such as a threaded wheel light, threaded valve cap, and/or threaded figurine designed to fit a common valve stem. The universal threaded novelty mount allows the attachment thereof.

### BACKGROUND OF THE INVENTION

It has become very popular to display various threaded novelty items on a vehicles valve stem these days. However it is often difficult to use the wide variety of existing threaded novelty items designed to thread onto a common American, and/or French mouth tire (tyre) valve stem for alternate applications other than fastening to said valve stem(s).

### SUMMARY OF THE INVENTION

One embodiment of the invention pertains to a threaded coupling structure having a top surface and a bottom surface, the top surface having one or more threaded coupling(s) including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm, wherein said top is integral of said bottom.

The threaded coupling structure may also have elements to allow attachment in various configurations, threaded shaft, magnetic force, form fitted, compression, adhesive, suction cup, tied or zip-tie, crimped, elastic, silicon, velcro, and/or none. The threaded coupling structure provides an attachment option for various threaded novelty items designed to thread onto a common valve stem such as schrader, dunlop-woods, presta, etc., typically conforming to International Organization For Standardization (ISO) 4570: 2002, tire (tyre) valve threads, and/or DIN specifications 7756. Wherein providing the ability to interchange the threaded novelty items to and from a valve stem, to any of the various preferred embodiments of the present invention, and/or provide many signaling, warning, and/or decorative options for the user.

### BRIEF DESCRIPTION OF DRAWINGS

NOTE: For simplicity of illustration, nuts, bolts, O-rings, washers and minutiae of common hardware are not depicted as they are known to those with skill in the art. When they are shown, it is purely for illustrative purposes and not intended to capture all embodiments of the invention disclosed.

FIG. 1 illustrates a threaded coupling structure that attaches to a bolt head according to one embodiment of the invention.

FIG. 2 illustrates a threaded coupling structure that attaches via suction cup according to one embodiment of the invention.

FIG. 3 illustrates a threaded coupling structure that attaches via adhesive according to one embodiment of the invention.

FIG. 4 illustrates a threaded coupling structure that attaches via threaded bolt, and/or through hole mounting with threaded bolt and/or fastener according to one embodiment of the invention.

FIG. 5a illustrates a threaded coupling structure that attaches to a mast, shaft, and/or rod according to one embodiment of the invention.

FIG. 5b illustrates a threaded coupling structure that attaches to a mast, shaft, and/or rod according to one embodiment of the invention.

FIG. 5c illustrates a threaded coupling structure that is a threaded mast, shaft, and/or rod according to one embodiment of the invention.

FIG. 5d illustrates a detailed view and use of a threaded coupling structure that is a threaded mast, shaft, and/or rod according to one embodiment of the invention.

FIG. 6a illustrates a threaded coupling structure that attaches via spring, or flexible membrane according to one embodiment of the invention.

FIG. 6b illustrates a detailed view and use of a threaded coupling structure that attaches to a spring or flexible membrane according to one embodiment of the invention.

FIG. 7a illustrates a threaded coupling structure that attaches via crimped and/or glued application according to one embodiment of the invention.

FIG. 7b illustrates the use of a threaded coupling structure with a rope and/or cable that attaches via crimped and/or glued application according to one embodiment of the invention.

FIG. 8 illustrates a threaded coupling structure that attaches via magnetic force according to one embodiment of the invention.

FIG. 9 illustrates a threaded coupling structure that attaches via clamp and/or zip-tie according to one embodiment of the invention.

FIG. 10 illustrates a threaded coupling structure that attaches via form fit according to one embodiment of the invention.

FIG. 11 illustrates a threaded coupling structure that attaches via form fit with adhesive according to one embodiment of the invention.

FIG. 12 illustrates a threaded coupling structure that attaches via form fit with magnetic force according to one embodiment of the invention.

FIG. 13 illustrates a threaded coupling structure that attaches via adhesive according to one embodiment of the invention.

FIG. 14 illustrates a threaded coupling structure that attaches via form fit with velcro according to one embodiment of the invention.

FIG. 15 illustrates a threaded coupling structure that attaches via elastic and/or rubber silicon according to one embodiment of the invention.

FIG. 16 illustrates use of the threaded coupling structure with an (ATV) all terrain vehicle.

FIG. 17 illustrates use of the threaded coupling structure with a golf cart, vehicle.

FIG. 18 illustrates use of the threaded coupling structure with a boat.

FIG. 19 illustrates use of the threaded coupling structure with a car, vehicle.

FIG. 20 illustrates use of the threaded coupling structure with a boat.

FIG. 21 illustrates use of the threaded coupling structure with a pencil.

FIG. 22 illustrates use of the threaded coupling structure with an (ATV) all terrain vehicle.

FIG. 23 illustrates use of the threaded coupling structure with a golf cart, vehicle.

FIG. 24 illustrates use of the threaded coupling structure with a mast.

FIG. 25 illustrates use of the threaded coupling structure with a wheel chair.

FIG. 26 illustrates use of the threaded coupling structure with an (ATV) all terrain vehicle.

FIG. 27 illustrates use of the threaded coupling structure with a boat.

### DETAILED DESCRIPTION OF THE PREFERRED EMBODIMENTS

In the following description, numerous specific details are set forth in order to provide a thorough understanding of the invention. However, one skilled in the art would recognize that the invention might be practiced without these specific details. In other instances, well known methods, procedures, and/or components have not been described in detail so as not to unnecessarily obscure aspects of the invention.

In the following description, certain terminology is used to describe certain components and features of one or more embodiments of the invention. For example, the term “mast” includes, but is not limited to, a flexible, or rigid pole, shaft, rod or staff. The term “coupling” includes, but is not limited to, a device that serves to connect the end of adjacent parts or objects. The term “threaded coupling” includes, but is not limited to, a threaded device that serves to connect the end of adjacent parts or objects. The term “thread and/or threads” includes, but is not limited to, a projecting helical rib (as in a fitting or on a pipe) by which parts can be screwed together. The term “threaded” includes, but is not limited to, a projecting helical rib (as in a fitting or on a pipe) by which parts can be screwed together. The term “TPI” includes, but is not limited to, threads per inch. The term “structure” includes, but is not limited to, the action of building, something that is constructed, something of formation. The term “surface” includes, but is not limited to, the exterior or upper boundary of an object or body. The term “integral” includes, but is not limited to, composed of constituent parts. The term “magnet and/or magnetic” includes, but is not limited to, a body having the property of attracting iron and producing a magnetic field external to itself; specifically: a mass of iron, steel, or alloy that has this property artificially imparted. The term “compression” includes, but is not limited to, the act, process, or result of compressing. The term “form” includes, but is not limited to, a visible and measurable unit defined by a contour. The term “adhesive” includes, but is not limited to, tending to adhere or cause adherence. The term “strap” includes, but is not limited to, something made of a strap forming a loop. The term “zip-tie” includes, but is not limited to, a plastic strip that can be threaded through its end and tightened so as to fasten something. The term “crimp and/or crimped” includes, but is not limited to, to pinch or press together. The term “elastic” includes, but is not limited to, capable of being easily stretched or expanded and resuming former shape. The term “suction” includes, but is not limited to, the act or process of exerting a force upon a solid, liquid, or gaseous body by reason of reduced air pressure over part of its surface. The term “silicone rubber” includes, but is not limited to, rubber made from silicone elastomers and noted for its retention of flexibility, resilience, and tensile strength over a wide temperature range.

FIG. 1 illustrates a threaded coupling structure 21 including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein a bolt head attachment method at said bottom 31 with a set screw 16 compression method to secure threaded coupling structure 21 to a bolt head, according to one embodiment of the invention. In various configurations, the threaded coupling structure 21 may have a solid composition, a hollow composition, and/or include multiple layers of materials. Preferably, the threaded coupling structure 21 may be made of a rigid material such as plastic, resin, metal, alloy, composite materials, etc., which allows it to provide a sturdy functional coupling structure. However, in other implementations, the threaded coupling structure 21 may be flexible and/or not rigid such as, rubber, silicone rubber, plastic, etc. However in other implementations various types of compression methods are used such as tapered, arbor, and/or ferrule, type compression methods, and/or simply force fitted, glued, and/or magnetically secured, and/or vary in size, shape, and/or diameter.

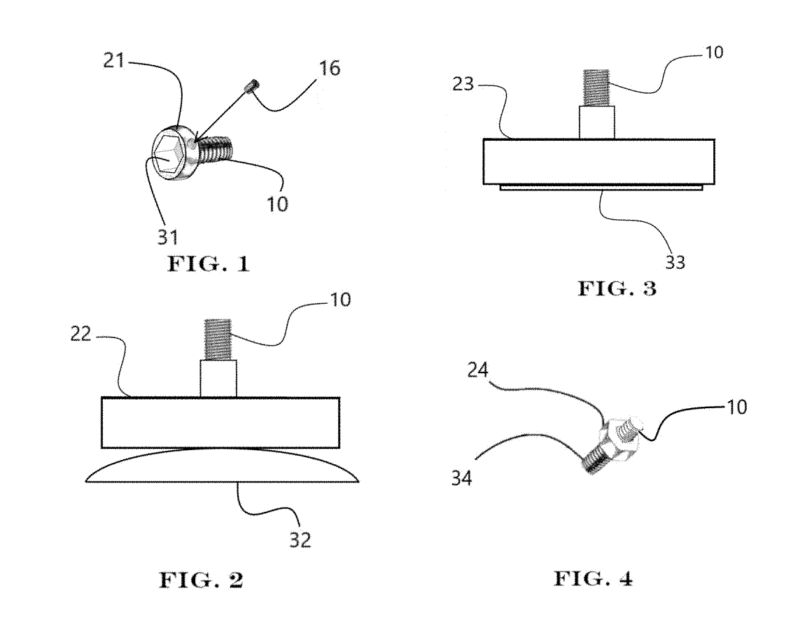

FIG. 2 illustrates a threaded coupling structure 22 including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein a suction cup attachment method at said bottom 32 is used to secure threaded coupling structure 22 to a flat, smooth, horizontal, and/or vertical surface, according to one embodiment of the invention. In various configurations, the threaded coupling structure 22 may have a solid composition, a hollow composition, and/or include multiple layers of materials. Preferably, the threaded coupling structure 22 may be made of a rigid material such as plastic, resin, metal, alloy, composite materials, etc., which allows it to provide a sturdy functional coupling structure. However, in other implementations, the threaded coupling structure 22 may be flexible and/or not rigid such as, rubber, silicone rubber, plastic, etc., and/or may vary in size, shape, and/or diameter.

FIG. 3 illustrates a threaded coupling structure 23 including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein an adhesive attachment method at said bottom 33 is used to secure threaded coupling structure 23 to a smooth, horizontal, and/or vertical surface, according to one embodiment of the invention. In various configurations, the threaded coupling structure 23 may have a solid composition, a hollow composition, and/or include multiple layers of materials. Preferably, the threaded coupling structure 23 may be made of a rigid material such as plastic, resin, metal, alloy, composite materials, etc., which allows it to provide a sturdy functional coupling structure. However, in other implementations, the threaded coupling structure 23 may be flexible and/or not rigid such as, rubber, silicone rubber, plastic, etc., and/or may vary in size, shape, and/or diameter.

FIG. 4 illustrates a threaded coupling structure 24 including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein a threaded and/or through hole attachment method at said bottom 34 is used to secure threaded coupling structure 24 to a through hole connection, and/or threaded stud to fit user specific size and/or thread preference, according to one embodiment of the invention. In various configurations, the threaded coupling structure 24 may have a solid composition, a hollow composition, and/or include multiple layers of materials. Preferably, the threaded coupling structure 24 may be made of a rigid material such as plastic, resin, metal, alloy, composite materials, etc., which allows it to provide a sturdy functional coupling structure. However, in other implementations, the threaded coupling structure 24 may be flexible, and/or not rigid such as, rubber, silicone rubber, plastic, etc., and/or may vary in size, shape, and/or diameter.

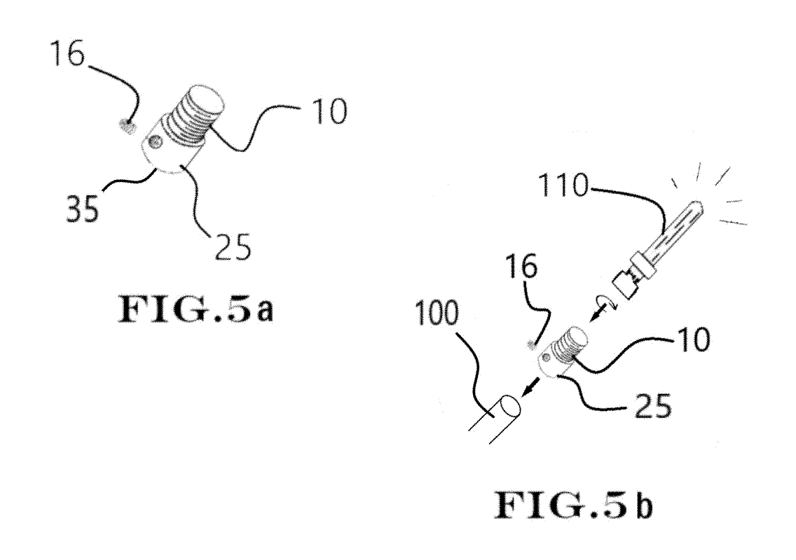

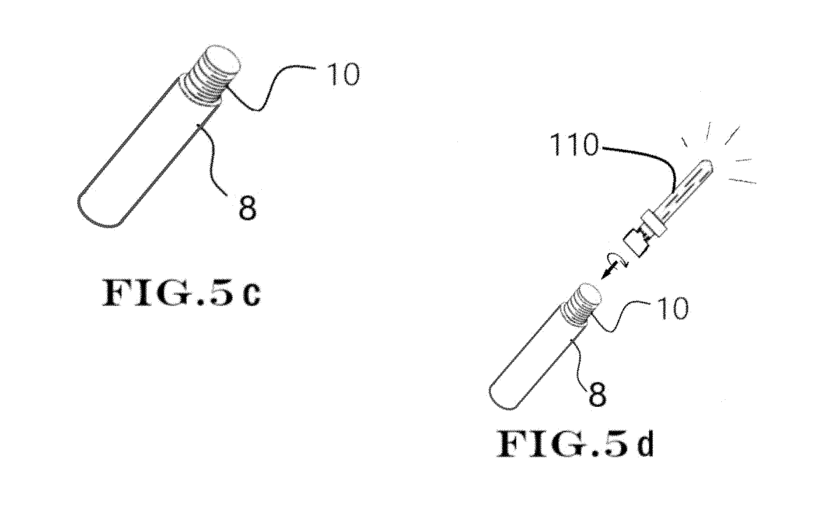

Referring now to FIGS. 5a-5b for a detailed view of a threaded coupling structure 25, FIG. 5a illustrates a threaded coupling structure 25 including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein an aperture at said bottom 35 utilizing a compression method with set screw 16, as FIG. 5b illustrates a detailed view and/or use of a threaded coupling structure 25 attaching to a mast 100 supporting a common threaded novelty item 110, according to one embodiment of the invention. In various configurations, the threaded coupling structure 25 may have a solid composition, a hollow composition, and/or include multiple layers of materials. Preferably, the threaded coupling structure 25 may be made of a rigid material such as plastic, resin, metal, alloy, composite materials, etc., which allows it to provide a sturdy functional coupling structure. However, in other implementations, the threaded coupling structure 25 may be flexible and/or not rigid such as, rubber, silicone rubber, plastic, etc., and/or may vary in size, shape, and/or diameter.

FIGS. 5c-5d illustrates a detailed view of a threaded coupling structure 8, FIG. 5c illustrates a threaded coupling structure 8 including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein a threaded coupling structure 8 is a mast, shaft, and/or rod at said bottom. FIG. 5d illustrates a detailed view and/or use of a threaded coupling structure 8 supporting a common threaded novelty item 110, according to one embodiment of the invention. In various configurations, the threaded coupling structure 8 may have a solid composition, a hollow composition, and/or include multiple layers of materials. Preferably, the threaded coupling structure 8 may be made of a rigid material such as plastic, resin, metal, alloy, composite materials, fiberglass, etc., which allows it to provide a sturdy functional coupling structure. However, in other implementations, the threaded coupling structure 8 may be flexible and/or not rigid such as, rubber, silicone rubber, plastic, etc., and/or may vary in size, shape, and/or diameter.

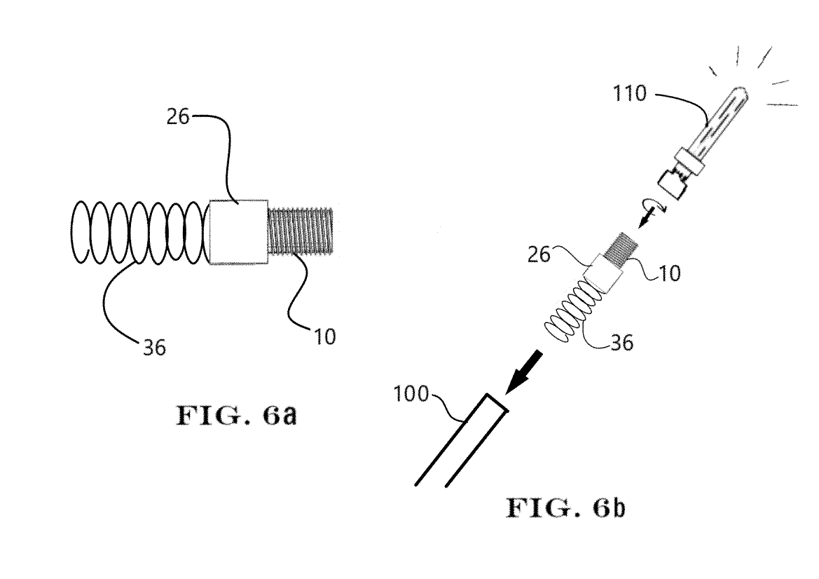

FIGS. 6a-6b illustrates a detailed view of a threaded coupling structure 26, FIG. 6a illustrates a threaded coupling structure 26 including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein a spring attachment method at said bottom 36 as FIG. 6b illustrates a detailed view and/or use of a threaded coupling structure 26 attaching to a mast 100 supporting a common threaded novelty item 110, according to one embodiment of the invention. In various configurations, the threaded coupling structure 26 may have a solid composition, a hollow composition, and/or include multiple layers of materials. Preferably, the threaded coupling structure 26 may be made of a rigid material such as plastic, resin, metal, alloy, composite materials, etc., which allows it to provide a sturdy functional coupling structure. However, in other implementations, the threaded coupling structure 26 may be flexible and/or not rigid such as, rubber, silicone rubber, plastic, etc., and/or may vary in size, shape, and/or diameter.

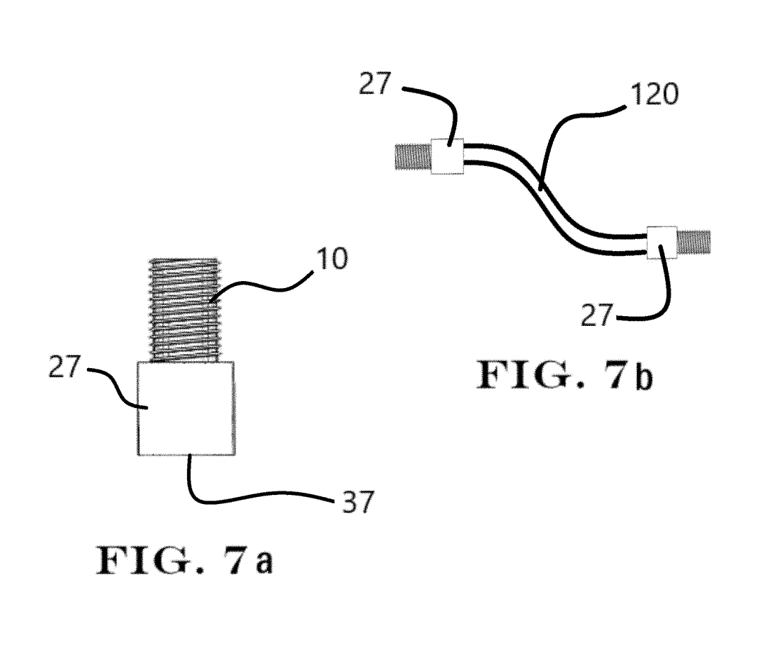

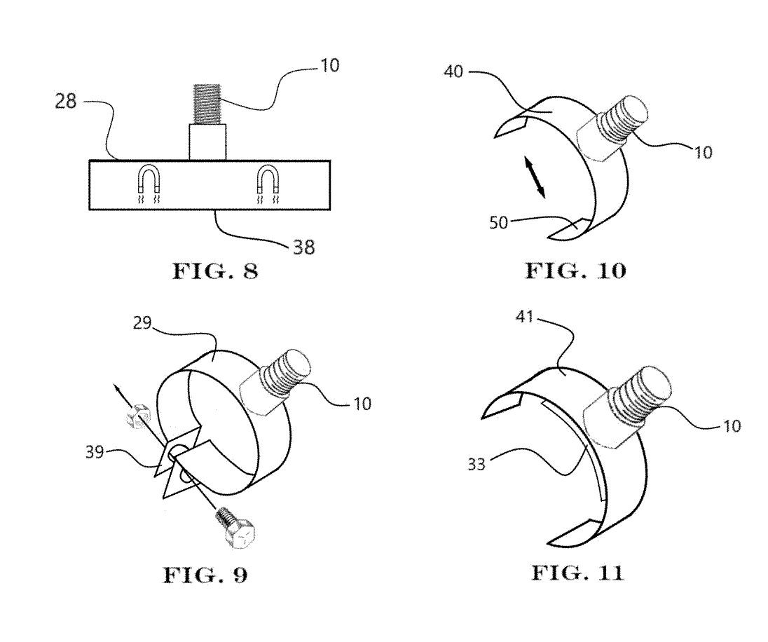

FIGS. 7a-7b illustrates a detailed view of a threaded coupling structure 27, FIG. 7a illustrates a threaded coupling structure 27 including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein a crimp, and/or glue attachment method at said bottom 37 as FIG. 7b illustrates a detailed view and/or use of a threaded coupling structure 27 attaching to a rope, and/or cable 120, according to one embodiment of the invention. In various configurations, the threaded coupling structure 27 may have a solid composition, a hollow composition, and/or include multiple layers of materials. Preferably, the threaded coupling structure 27 may be made of a rigid material such as plastic, resin, metal, alloy, composite materials, etc., which allows it to provide a sturdy functional coupling structure. However, in other implementations, the threaded coupling structure 27 may be flexible and/or not rigid such as, rubber, silicone rubber, plastic, etc., and/or may vary in size, shape, and/or diameter.

FIG. 8 illustrates a threaded coupling structure 28 including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein a magnetic attachment method at said bottom 38 is used to secure threaded coupling structure 28 to a metallic surface such as a car, refrigerator, metal, etc., according to one embodiment of the invention. In various configurations, the threaded coupling structure 28 may have a solid composition, a hollow composition, and/or include multiple layers of materials. Preferably, the threaded coupling structure 28 may be made of a rigid material such as plastic, resin, metal, alloy, composite materials, etc., which allows it to provide a sturdy functional coupling structure. However, in other implementations, the threaded coupling structure 28 may be flexible and/or not rigid such as, rubber, silicone rubber, plastic, etc., and/or may vary in size, shape, and/or diameter.

FIG. 9 illustrates a threaded coupling structure 29 including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein a formed clamping attachment method at said bottom 39 is used to secure threaded coupling structure 29 to a predetermined shape and/or size, according to one embodiment of the invention. In various configurations, the threaded coupling structure 29 may have a solid composition, a hollow composition, and/or include multiple layers of materials. Preferably, the threaded coupling structure 29 may be made of a rigid material such as plastic, resin, metal, alloy, composite materials, etc., which allows it to provide a sturdy functional coupling structure. However, in other implementations, the threaded coupling structure 29 may be flexible and/or not rigid such as, rubber, silicone rubber, plastic, etc., and/or may vary in size, shape, and/or diameter.

FIG. 10 illustrates a threaded coupling structure 40 including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein a formed fit attachment method at said bottom 50 is used to secure threaded coupling structure 40 to a predetermined shape and/or size, according to one embodiment of the invention. In various configurations, the threaded coupling structure 40 may have a solid composition, a hollow composition, and/or include multiple layers of materials. Preferably, the threaded coupling structure 40 may be made of a rigid material such as plastic, resin, metal, alloy, composite materials, etc., which allows it to provide a sturdy functional coupling structure. However, in other implementations, the threaded coupling structure 40 may be flexible and/or not rigid such as, rubber, silicone rubber, plastic, etc., and/or may vary in size, shape, and/or diameter.

FIG. 11 illustrates a threaded coupling structure 41 including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein an adhesive attachment method at said bottom 33 is used to secure threaded coupling structure 41 to a predetermined shape and/or size, according to one embodiment of the invention. In various configurations, the threaded coupling structure 41 may have a solid composition, a hollow composition, and/or include multiple layers of materials. Preferably, the threaded coupling structure 41 may be made of a rigid material such as plastic, resin, metal, alloy, composite materials, etc., which allows it to provide a sturdy functional coupling structure. However, in other implementations, the threaded coupling structure 41 may be flexible and/or not rigid such as, rubber, silicone rubber, plastic, etc., and/or may vary in size, shape, and/or diameter.

FIG. 12 illustrates a threaded coupling structure 42 including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein a magnetic attachment method at said bottom 38 is used to secure threaded coupling structure 42 to a predetermined shape and/or size, according to one embodiment of the invention. In various configurations, the threaded coupling structure 42 may have a solid composition, a hollow composition, and/or include multiple layers of materials. Preferably, the threaded coupling structure 42 may be made of a rigid material such as plastic, resin, metal, alloy, composite materials, etc., which allows it to provide a sturdy functional coupling structure. However, in other implementations, the threaded coupling structure 42 may be flexible and/or not rigid such as, rubber, silicone rubber, plastic, etc., and/or may vary in size, shape, and/or diameter.

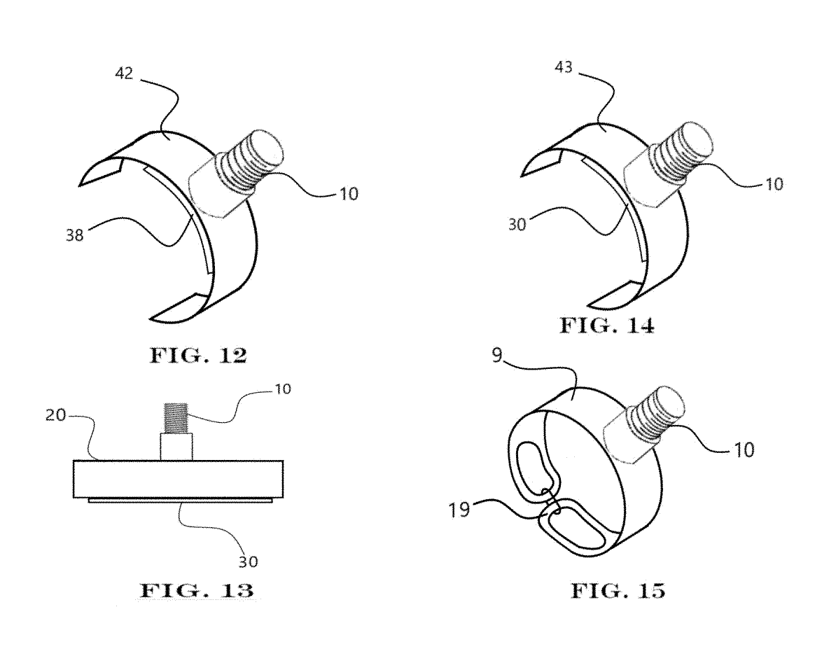

FIG. 13 illustrates a threaded coupling structure 20 including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein a velcro attachment method at said bottom 30 is used to secure threaded coupling structure 20 to a predetermined shape and/or size, according to one embodiment of the invention. In various configurations, the threaded coupling structure 20 may have a solid composition, a hollow composition, and/or include multiple layers of materials. Preferably, the threaded coupling structure 20 may be made of a rigid material such as plastic, resin, metal, alloy, composite materials, etc., which allows it to provide a sturdy functional coupling structure. However, in other implementations, the threaded coupling structure 20 may be flexible and/or not rigid such as, rubber, silicone rubber, plastic, etc., and/or may vary in size, shape, and/or diameter.

FIG. 14 illustrates a threaded coupling structure 43 including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein a velcro attachment method at said bottom 30 is used to secure threaded coupling structure 43 to a predetermined shape and/or size, according to one embodiment of the invention. In various configurations, the threaded coupling structure 43 may have a solid composition, a hollow composition, and/or include multiple layers of materials. Preferably, the threaded coupling structure 43 may be made of a rigid material such as plastic, resin, metal, alloy, composite materials, etc., which allows it to provide a sturdy functional coupling structure. However, in other implementations, the threaded coupling structure 43 may be flexible and/or not rigid such as, rubber, silicone rubber, plastic, etc., and/or may vary in size, shape, and/or diameter.

FIG. 15 illustrates a threaded coupling structure 9 including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein an elastic attachment method at said bottom 19 is used to secure threaded coupling structure 9 to various shape and/or size structures, according to one embodiment of the invention. In various configurations, the threaded coupling structure 9 may have a solid composition, a hollow composition, and/or include multiple layers of materials. Preferably, the threaded coupling structure 9 may be made of a rigid material such as plastic, resin, metal, alloy, composite materials, etc., which allows it to provide a sturdy functional coupling structure. However, in other implementations, the threaded coupling structure 9 may be flexible and/or not rigid such as, rubber, silicone rubber, plastic, etc., and/or may vary in size, shape, and/or diameter.

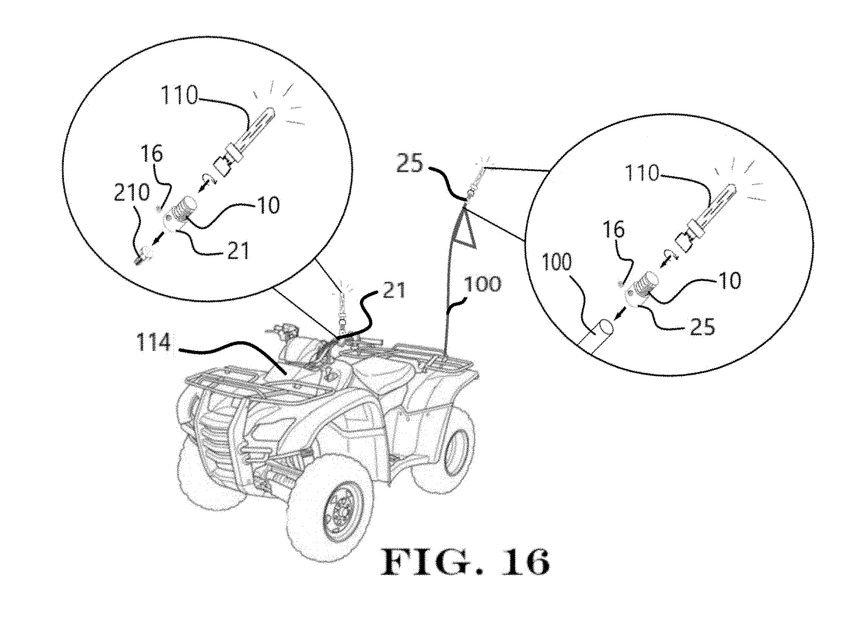

FIG. 16 illustrates a threaded coupling structure 21 as shown in FIG. 1 attached to an ATV, vehicle 114, including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein a compression attachment method, set screw 16 is used to secure threaded coupling structure 21 to a bolt head 210, and/or a predetermined shape and/or size, according to one embodiment of the invention. A threaded coupling structure 25 as shown in FIGS. 5a-5b is attached to a mast 100 on an ATV, vehicle 114, including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, illustrating the versatility and/or expanded use of attaching common threaded novelty items 110 designed to fit a common valve stem.

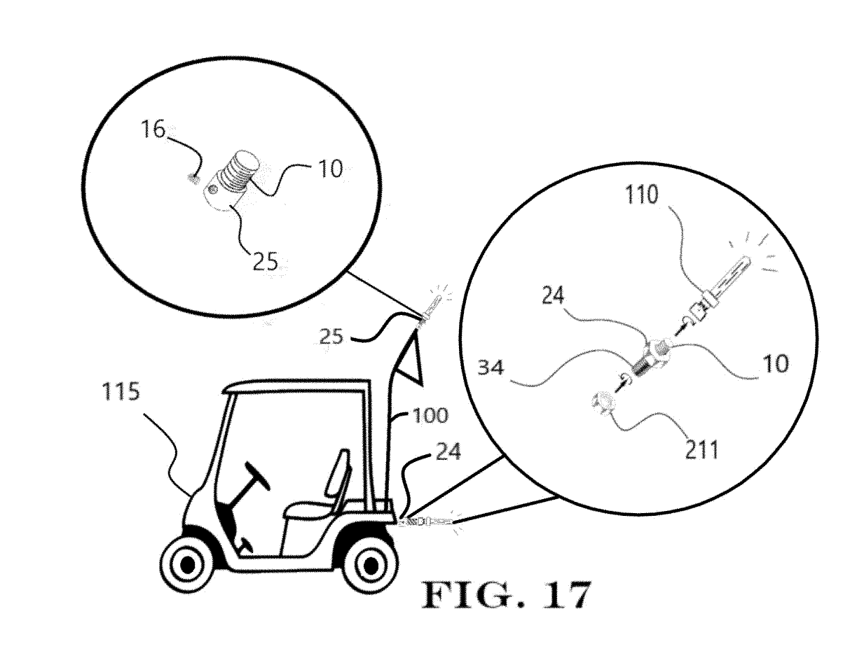

FIG. 17 illustrates a threaded coupling structure 25 as shown in FIGS. 5a-5b and FIG. 16 attached to a mast 100 on a golf cart, vehicle 115 including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein a compression attachment method, set screw 16 is used to secure threaded coupling structure 25 to a mast 100, according to one embodiment of the invention. A threaded coupling structure 24 as shown in FIG. 4 is attached to a golf cart, vehicle 115, including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein through hole attachment method 34 secured with a nut 211, illustrating the versatility and/or expanded use of attaching common threaded novelty items 110 designed to fit a common valve stem.

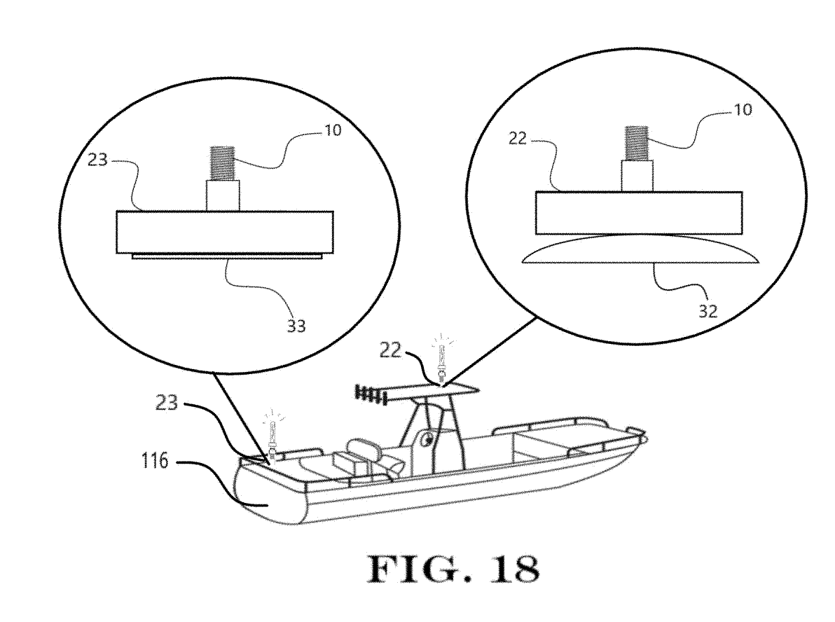

FIG. 18 illustrates a threaded coupling structure 23 as shown in FIG. 3 attached to a boat 116 including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein an adhesive attachment method 33 is used to secure threaded coupling structure 23 to a smooth, horizontal, and/or vertical surface, according to one embodiment of the invention. A threaded coupling structure 22 as shown in FIG. 2 is attached to a boat 116, including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein a suction cup attachment method 32 is used to secure threaded coupling structure 22 to a flat, smooth, horizontal, and/or vertical surface, according to one embodiment of the invention.

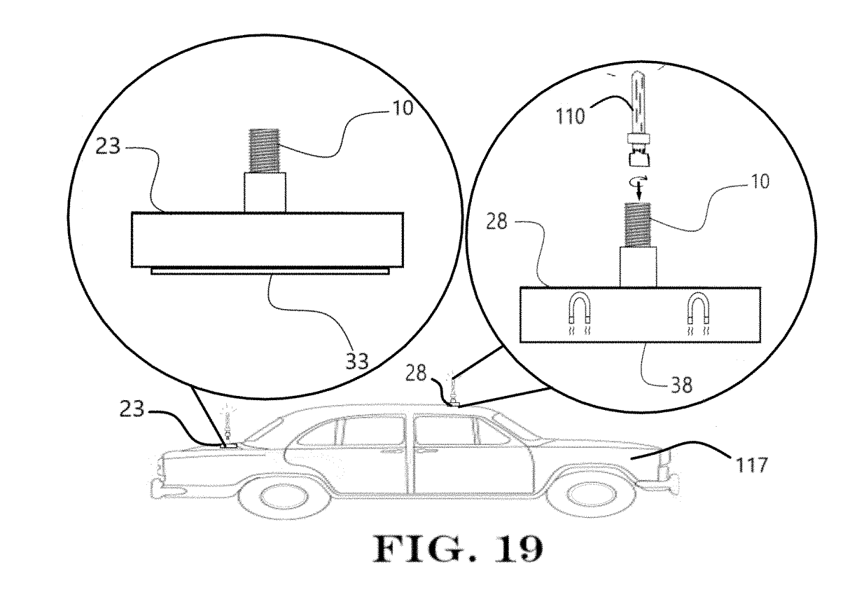

FIG. 19 illustrates a threaded coupling structure 23 as shown in FIG. 3 and FIG. 18 attached to a car, vehicle 117 including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein an adhesive attachment method 33 is used to secure threaded coupling structure 23 to a horizontal, and/or vertical surface, according to one embodiment of the invention. A threaded coupling structure 28 as shown in FIG. 8 is attached to a car, vehicle 117 including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein a magnetic attachment method 38 is used to secure threaded coupling structure 28 to a metallic surface such as a car, refrigerator, metal, etc., illustrating the versatility and/or expanded use of attaching common threaded novelty items 110 designed to fit a common valve stem according to one embodiment of the invention.

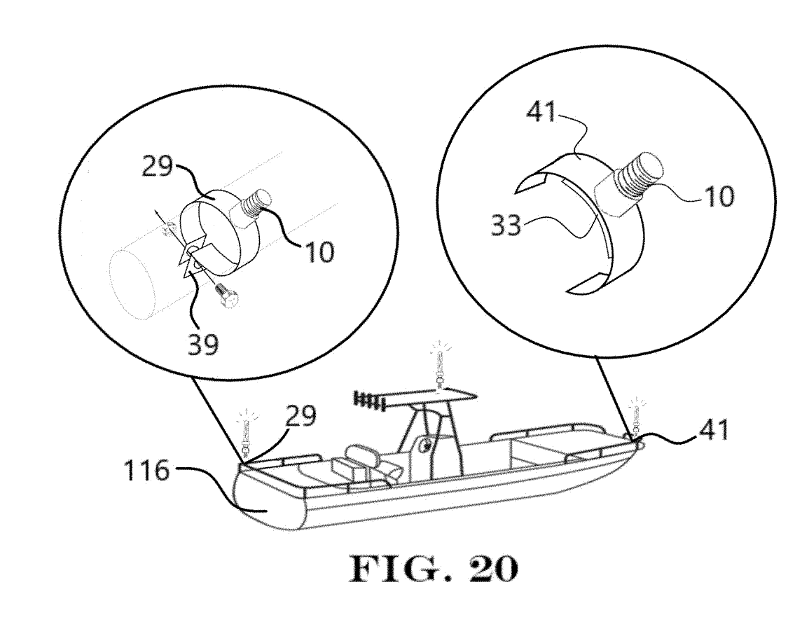

FIG. 20 illustrates a threaded coupling structure 29 as shown in FIG. 9 attached to the railing of a boat 116 including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein a clamp attachment method 39 is used to secure threaded coupling structure 29 to a predetermined shape and/or size, such as the railing of a boat 116, according to one embodiment of the invention. A threaded coupling structure 41 as shown in FIG. 11 is attached to a boat 116, including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10 wherein an adhesive attachment method 33 is used to secure threaded coupling structure 41 to a predetermined shape and/or size, such as the railing of a boat 116, according to one embodiment of the invention.

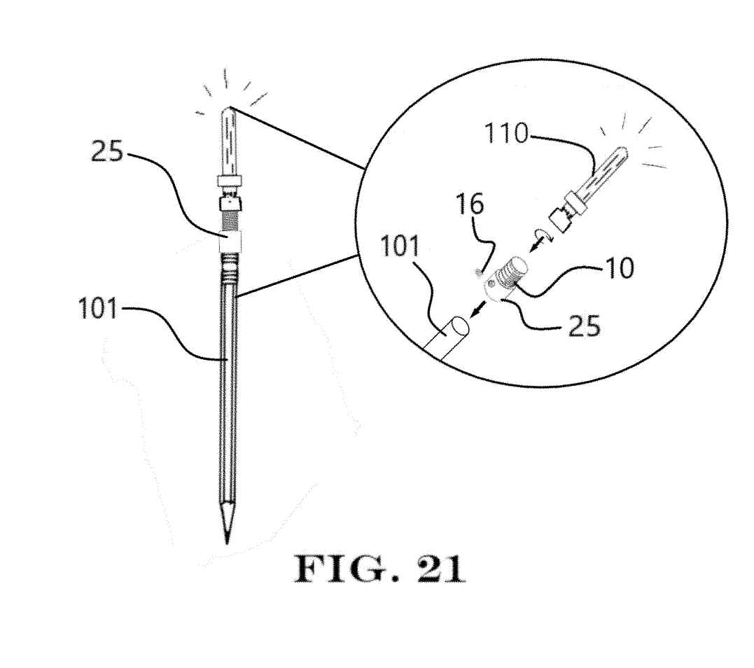

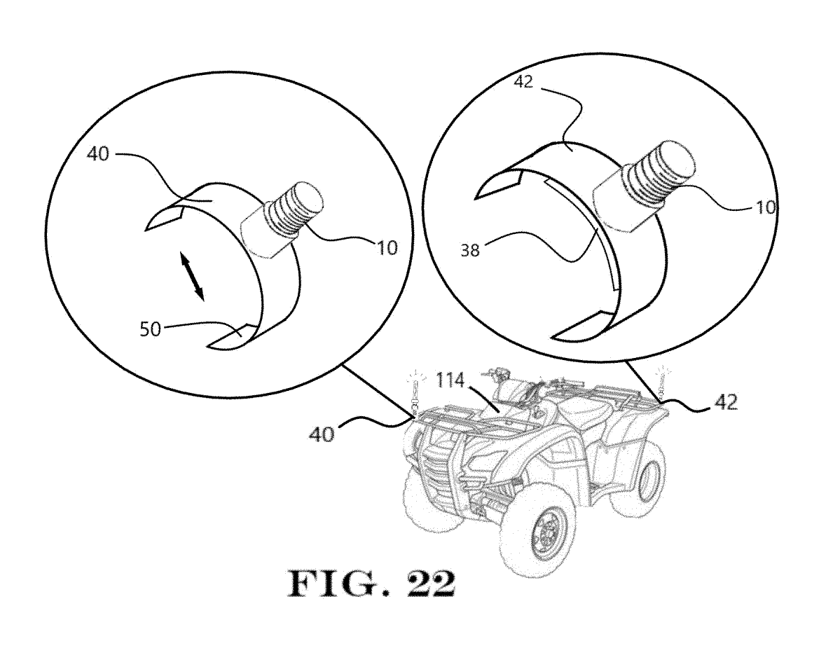

FIG. 21 illustrates a threaded coupling structure 25 as shown in FIGS. 5a-5b, FIG. 16, and FIG. 17 attached to a pencil 101, including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein a set screw compression attachment method 16 is used to secure threaded coupling structure 25 to a pencil 101, illustrating the versatility and/or expanded use of attaching common threaded novelty items 110 designed to fit a common valve stem according to one embodiment of the invention.

FIG. 22 illustrates a threaded coupling structure 40 as shown in FIG. 10 attached to the railing of an ATV, vehicle 114 including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm 10, wherein a form fit attachment method 50 is used to secure threaded coupling structure 40 to a predetermined shape and/or size, such as the railing of an ATV, vehicle 114, according to one embodiment of the invention. A threaded coupling structure 42 as shown in FIG. 12 is attached to the railing of an ATV, vehicle 114 including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25) 10, wherein a magnetic attachment method 38 is used to secure threaded coupling structure 42 to a predetermined shape and/or size, such as the railing of an ATV, vehicle 114, according to one embodiment of the invention.

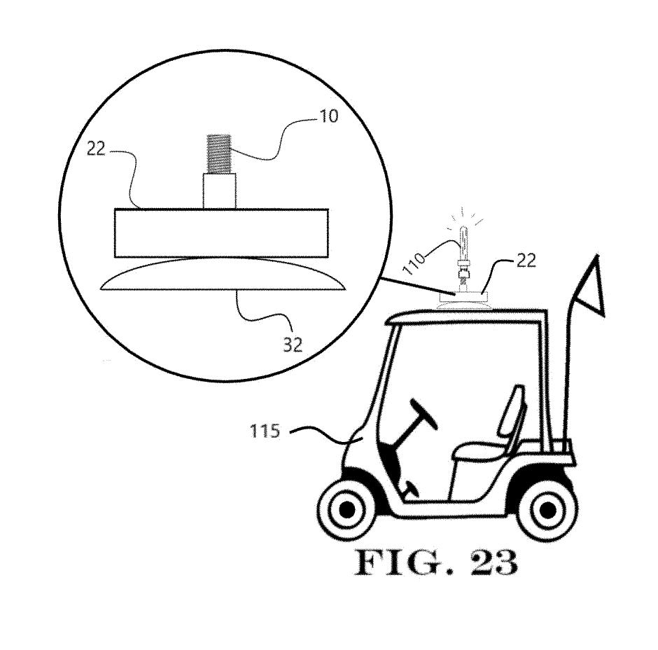

FIG. 23 illustrates a threaded coupling structure 22 as shown in FIG. 2, and FIG. 18 attached to a golf cart, vehicle 115, including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein a suction cup attachment method 32 is used to secure threaded coupling structure 22 to a flat, smooth, horizontal, and/or vertical surface, illustrating the versatility and/or expanded use of attaching common threaded novelty items 110 designed to fit a common valve stem according to one embodiment of the invention.

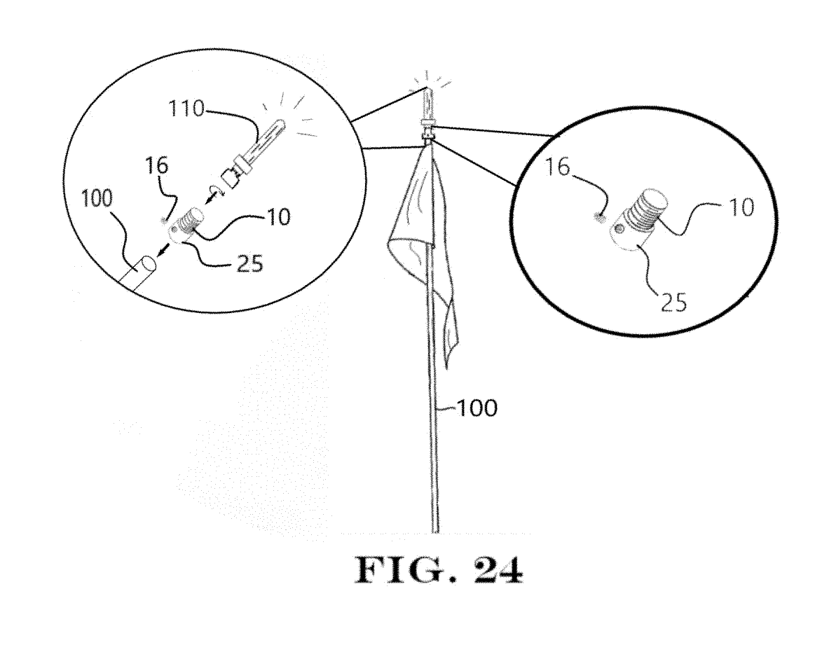

FIG. 24 illustrates a threaded coupling structure 25 as shown in FIGS. 5a-5b, FIG. 16, FIG. 17, and FIG. 21 attached to a mast 100, including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein a set screw compression attachment method 16 is used to secure threaded coupling structure 25 to a mast 100, illustrating the versatility and/or expanded use of attaching common threaded novelty items 110 designed to fit a common valve stem according to one embodiment of the invention.

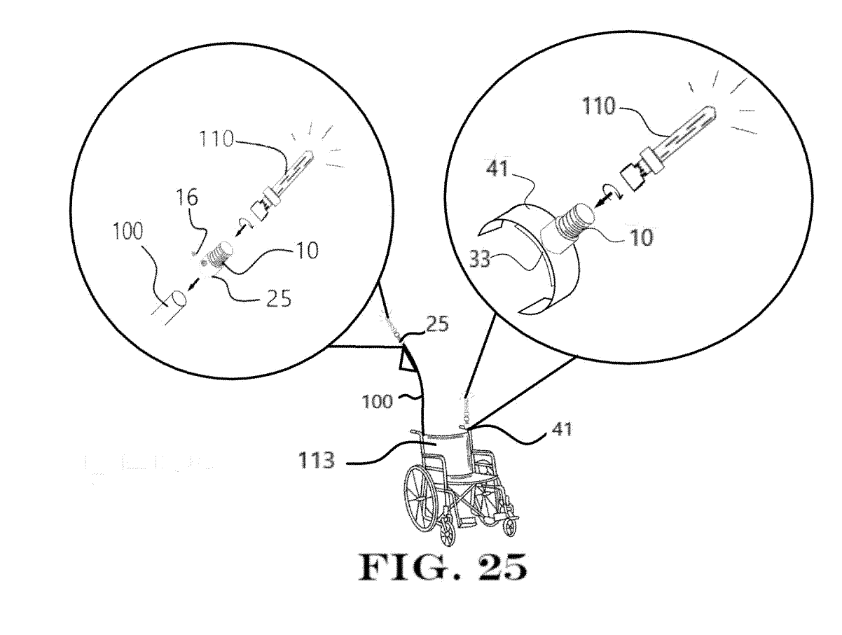

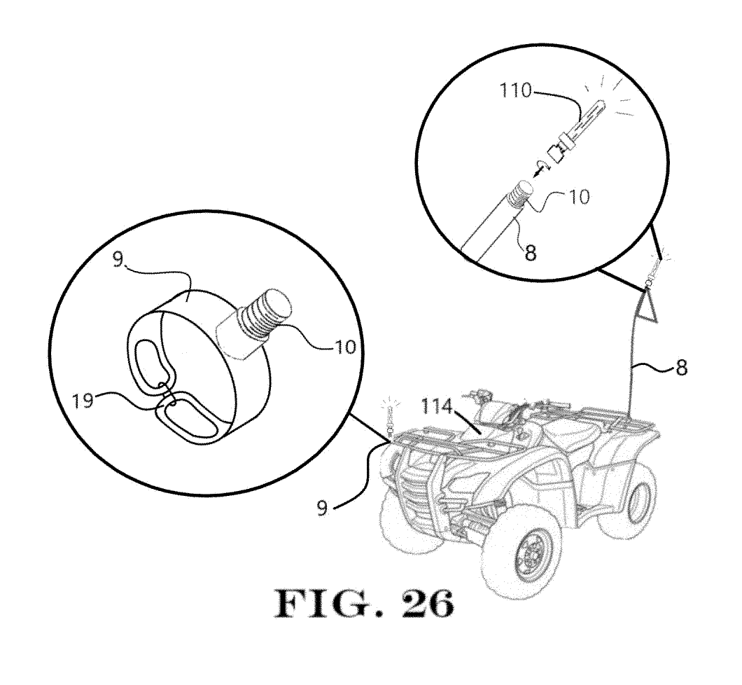

FIG. 25 illustrates a threaded coupling structure 25 as shown in FIGS. 5a-5b, FIG. 16, FIG. 17, FIG. 21, and FIG. 24 attached to a mast 100 on a wheelchair 113, including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein a set screw compression attachment method 16 is used to secure threaded coupling structure 25 to a mast 100, according to one embodiment of the invention. A threaded coupling structure 41 as shown in FIG. 11 is attached to the railing of a wheelchair 113 including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein an adhesive attachment method 33 is used to secure threaded coupling structure 41 to a predetermined shape and/or size, such as the railing of a wheelchair 113, illustrating the versatility and/or expanded use of attaching common threaded novelty items 110 designed to fit a common valve stem according to one embodiment of the invention.

FIG. 26 illustrates a threaded coupling structure 9 as shown in FIG. 15 attached the railing of an ATV, vehicle 114, including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein an elastic attachment method 19 is used to secure threaded coupling structure 9 to a predetermined shape and/or size, such as the railing of an ATV, vehicle 114, according to one embodiment of the invention. A threaded coupling structure 8 as shown in FIGS. 5c-5d is illustrated with an ATV, vehicle 114, including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein a threaded mast 8 supports a common threaded novelty item 110 designed to fit a common valve stem, according to one embodiment of the invention.

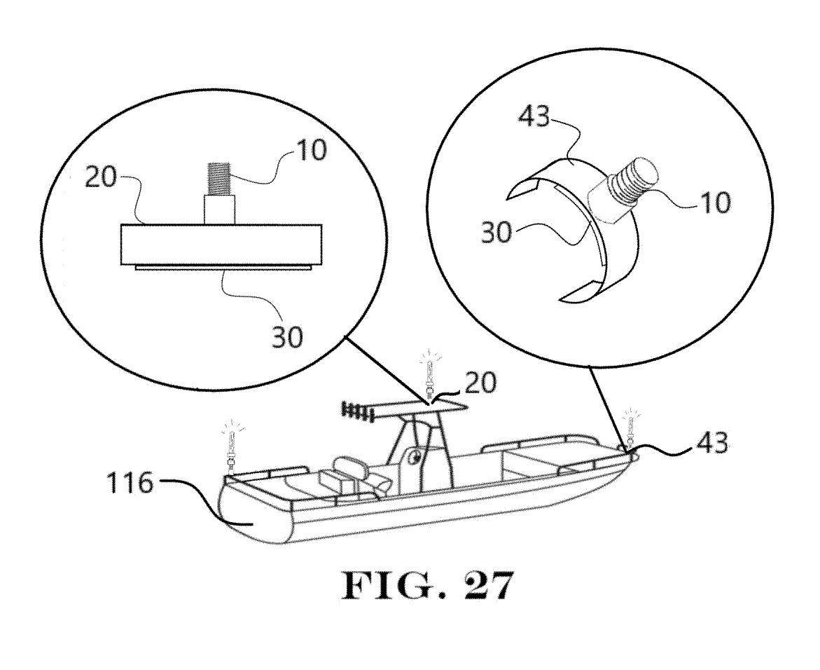

FIG. 27 illustrates a threaded coupling structure 20 as shown in FIG. 13 attached to a boat 116, including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein a velcro attachment method 30 is used to secure threaded coupling structure 20 to a predetermined shape and/or size. A threaded coupling structure 43 as shown in FIG. 14 is attached to a boat 116, including an American mouth thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm, and/or French mouth thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm. 10, wherein a velcro attachment method 30 is used to secure threaded coupling structure 43 to a predetermined shape and/or size, according to one embodiment of the invention.

One or more of the components and functions illustrated in FIGS. 1, 2, 3, 4, 5a, 5b, 5c, 5d, 6a, 6b, 7a, 7b, 8, 9, 10, 11, 12, 13, 14 and/or 15 may be rearranged and/or combined into a single component or embodied in several components without departing from the invention. Additional elements or components may also be added without departing from the invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications are possible. Those skilled, in the art will appreciate that various adaptations and modifications of the just described preferred embodiment can be configured without departing from the scope and spirit of the invention. Therefore, it is to be understood that, within the scope of the appended claims, the invention may be practiced other than as specifically described herein.

What is claimed is:

1. A threaded coupling structure for mounting a threaded novelty item such as a threaded wheel light, threaded valve cap, and/or threaded figurine designed to thread onto a common American, and/or French mouth tire (tyre) valve stem, said threaded coupling structure comprising:
a top surface and a bottom surface, the top surface having one or more threaded coupling(s); and wherein said top is integral of said bottom.

2. The threaded coupling structure according to claim 1, wherein said top surface having at least one threaded coupling with a thread and/or size ranging from 0.2756″ (7.0000 mm) diameter to 0.315″ (8.0000 mm) diameter, wherein a thread count ranging from 36 TPI to 28 TPI, and/or metric thread pitch ranging from 0.7 mm to 0.9 mm.

3. The threaded coupling structure according to claim 1, wherein said top surface having at least one threaded coupling with a thread and/or size ranging from 0.1575″ (4.0000 mm) diameter to 0.201″ (5.1000 mm) diameter, wherein a thread count ranging from 28 TPI to 20 TPI, and/or metric thread pitch ranging from 0.8 mm to 1.25 mm.

4. The threaded coupling structure according to claim 1, wherein said top is integral of said bottom, and/or bottom further comprises a mounting structure.

5. The threaded coupling structure according to claim 4, wherein said mounting structure may be made of a rigid material such as fiberglass, plastic, resin, metal, alloy, and/or composite materials etc., and/or may vary in size, shape, and/or diameter.

6. The threaded coupling structure according to claim 4, wherein said mounting structure may be flexible and/or not rigid such as, rubber, silicone rubber, plastic, etc., and/or may vary in size, shape, and/or diameter.

7. The threaded coupling structure according to claim 4, wherein said mounting structure is secured using various fastening methods; bolted, screwed, threaded mast, magnetic, compression, form, adhesive, strap, clamp, zip-tie, spring, crimp, elastic, fastener, velcro, suction, silicone, rubber, band, o-ring, and/or none.

8. The threaded coupling structure according to claim 4, wherein said mounting structure may be a mast, rod, and/or shaft, and/or may vary in length, and/or diameter.
